(19) United States
(12) Patent Application Publication
(10) Pub. No.: US 2016/0351288 A1
(43) Pub. Date: Dec. 1, 2016

(54) SYSTEMS AND METHODS FOR PROVIDING TUNABLE MULTIFUNCTIONAL COMPOSITES

(71) Applicant: Rhode Island Board of Education, State of Rhode Island and Providence Plantations, Providence, RI (US)

(72) Inventors: Nicholas HEEDER, Saunderstown, RI (US); Arun SHUKLA, Wakefield, RI (US)

(21) Appl. No.: 14/727,127

(22) Filed: Jun. 1, 2015

(51) Int. Cl. H01B 1/20; H01B 1/22; B05D 3/00; H01B 1/24

(52) U.S. Cl. CPC H01B 1/20; H01B 1/24; H01B 1/22; B05D 3/007

(57) ABSTRACT

A method is disclosed for forming a multifunctional electrically conductive composite. The method includes the steps of coating an electrically conductive material on particles of a polymeric material, and applying a stress force on the coated polymeric material to cause the polymeric material to become deformed and the electrically conductive material to break into smaller sized particles.

### BACKGROUND

The desire to produce light-weight, multi-functional composites has grown tremendously in recent years. Polymer nanocomposites, in particular, have attracted significant attention in the past decades with the belief that they could become the next generation of high performance materials with multifunctional capabilities. One of the most compelling features of polymer nanocomposites is the ability to create a new class of materials with attributes that come both from the filler and the matrix. Having the ability to manipulate the degree and nature of the dispersion is key to the development of these types of novel composites. Many studies have documented enhancement of properties such as stiffness and strength, thermal stability, electrical and thermal conductivities, dielectric performance and gas barrier properties of polymer composites with the incorporation of fillers.

Significant research has shown that carbon-based polymer nanocomposites demonstrate remarkable physical and mechanical properties by incorporating very small amounts of filler material. Owing to its extraordinary mechanical and physical properties, graphene appears to be a very attractive filler material for the next generation of smart materials in batteries, supercapacitors, fuel cells, photovoltaic devices, sensing platforms and other devices. Along with the aspect ratio and the surface-to-volume ratio, the distribution of filler material in a polymer matrix has been shown to directly correlate with its effectiveness in improving material properties such as mechanical strength, electrical and thermal conductivity, and impermeability.

Since the discovery of graphene, there has been a significant research effort put forth to effectively disperse these highly conductive particles inside of polymers to produce an electrically conductive composite. Although significant research has been performed to develop strategies to effectively incorporate nanoparticles into polymers, ability to control the dispersion and location of graphene-based fillers to fully exploit their intrinsic properties remains a challenge, especially at the pilot and commercial scales. An alternate method for creating a connected pathway for conductive particles is to make segregated composites. The conductive particles within segregated composites are specially localized on the surfaces of the polymer matrix particles. When consolidated into a monolith, these conductive particles form a percolating three-dimensional network that dramatically increases the conductivity of the composite. These studies revealed that highly conductive composites can be created when graphene is segregated into organized networks throughout a matrix material. Although the highly segregated networks provide excellent transport properties throughout the composite, they inevitably result in poor mechanical strength, since fracture can occur easily by delamination along the continuous segregated graphene phase. Since most multi-functional materials are required to provide excellent transport properties while maintaining sufficient mechanical strength, alternative methods of distributing graphene need to be developed.

Despite recent progresses on the electrical characterization of graphene-based segregated composites, no results have yet been published regarding the combined electro-mechanical behavior of these highly conductive materials.

In addition to providing exceptional transport properties (electrical and thermal conductivity), segregated composites can provide other superior properties including barrier properties if properly distributed/oriented throughout the matrix.

### SUMMARY

In accordance with an embodiment, the invention provides a method for forming a multi-functional electrically conductive composite. The method includes the steps of coating an electrically conductive material on particles of a polymeric material, and applying a stress force on the coated polymeric material to cause the polymeric material to become deformed and the electrically conductive material to break into smaller sized particles.

In accordance with another embodiment, the invention provides an electrically conductive composite that includes a plurality of particles of polymeric material and a conductive material. The conductive material at least partially covers the plurality of particles of polymeric material, and a first portion of the composite has undergone a stress force that has deformed a first portion of the polymeric material and broken up the conductive material associated with the first portion of the polymeric material.

In accordance with a further embodiment, the invention provides an electrically conductive composite that includes a polymeric material that has undergone a stress force, and a plurality of particles of conductive material that are dispersed within the composite

### BRIEF DESCRIPTION OF THE DRAWINGS

The following description may be further understood with reference to the accompanying drawings in which:

FIG. 1 shows an illustrative schematic view of capillary-driven particle-level templating to fabricate highly conductive graphite nanoplatelets (GNPs)/polystyrene composites in accordance with an embodiment of the present invention;

FIGS. 2A and 2B show illustrative schematic views of compression molding process to produce (a) organized template composites, and (b) shear-modified template composites in accordance with an embodiment of the present invention;

FIG. 3 shows an illustrative diagrammatic view of a compression molding apparatus in accordance with an embodiment of the present invention;

FIG. 4 shows illustrative optical microscope images of (a) top-surface and (b) cross-section of a 0.05% v/v GNP/PS composite in accordance with an embodiment of the present invention;

FIG. 5 shows an illustrative graphical representation of electrical conductivity of GNP/PS composite material with organized segregation as a function of graphene content in accordance with an embodiment of the present invention;

FIG. 6 shows a scanning electron microscope (SEM) image of a 5% v/v GNP/PS segregated composite prepared by the capillary-driven coating process in accordance with an embodiment of the present invention;

FIG. 7 an illustrative graphical representation of the effect of graphene content on flexural strength GNP/PS organized particle template composites in accordance with an embodiment of the present invention;

FIG. 8 shows an illustrative graphical representation of electro-mechanical behavior of GNP/PS organized particle templated composites parallel to pressing in accordance with an embodiment of the present invention;

FIGS. 9A, 9B and 9C show illustrative optical images of (a) top smeared surface, (b) bottom organized surface, and (c) cross-section of a 0.3% v/v GNP/PS shear-modified composite showing the extent of smearing in accordance with an embodiment of the present invention;

FIG. 10 shows an illustrative graphical representation of electrical conductivity of GNP/PS composite with a shear-modified segregated structure as a function of rotation angle; and

FIG. 11 shows an illustrative graphical representation of electro-mechanical behavior of the shear-modified GNP/PS particle template composites loaded parallel to pressing.

The drawings are shown for illustrative purposes only.

### DETAILED DESCRIPTION

A capillary-driven, particle-level templating technique was utilized to distribute graphite nanoplatelets (GNPs) into specially constructed architectures throughout a polystyrene (PS) matrix to form multi-functional composites with tailored electro-mechanical properties. By precisely controlling the temperature and pressure during a melt compression process, highly conductive composites were formed using very low loadings of graphene particles. To improve the mechanical properties, a new processing technique was developed that uses rotary shear during the compression molding process to gradually evolve the honeycomb graphene network into a concentric band structure. The rearrangement of the graphene networks allows for a higher degree of conformation and increased number of interactions between the polymer chains, thus providing increased strength in the polymeric phase. The degree of evolution from the honeycomb to the concentric band structure can be precisely determined by the chosen angle of rotation.

Two types of composites, organized and shear-modified, were produced to demonstrate the electro-mechanical tailoring of the composite material. An experimental investigation was conducted to understand the effect of graphene content as well as shearing on the mechanical strength and electrical conductivity of the composites. The experimental results show that both the mechanical and electrical properties of the composites can be altered using this very simple technique and the inherent tradeoff between electrical versus mechanical performance can be intelligently optimized for a given application by controlling the pre-set angle of rotary shear.

Since the graphene flakes form a honeycomb percolating network along the boundaries between the polymer matrix particles, the composites show very high electrical conductivity but poor mechanical strength. To improve the mechanical properties, a new processing technique was developed that uses rotary shear through pre-set fixed angles to gradually evolve the honeycomb graphene network into a concentric band structure over the dimensions of the sample.

An experimental investigation was conducted to understand the effect of GNP loading as well as rotary shear angle on the mechanical strength and electrical conductivity of the composites. The experimental results show that both the electrical and mechanical properties of the composites are significantly altered using this very simple technique, which allows rational co-optimization of competing mechanical and electrical performance as appropriate for a given target application.

The graphite nanoplatelets used were xGnP™ Nanoplatelets (XG Sciences, USA). These nanoparticles consist of short stacks of graphene layers having a lateral dimension of ˜25 lm and a thickness of ˜6 nm. This thickness corresponds to approximately 18 graphene layers at a typical graphite interlayer spacing. It has been proposed that materials of this thickness (>10 layers) be referred to as exfoliated graphite, or graphite nanoplatelets for scientific classification. The same materials are sometimes marketed by suppliers as graphene nanoplatelets. The polymeric material chosen was polystyrene (Crystal PS 1300, average molecular weight of 121,000 g/mol) purchased from Styrolution, USA. The PS pellets used were elliptical prisms with an average diameter of 2.76 mm and a length of 3.21 mm.

Examples of various polymeric materials that may be used include polypropylene (PP), polyethylene (PE, LDPE, HDPE), high impact polystyrene (HIPS), vinyl, nylon, polybutylene (PB) plastics, polyimide (PI), or polyphthalamide (PPA).

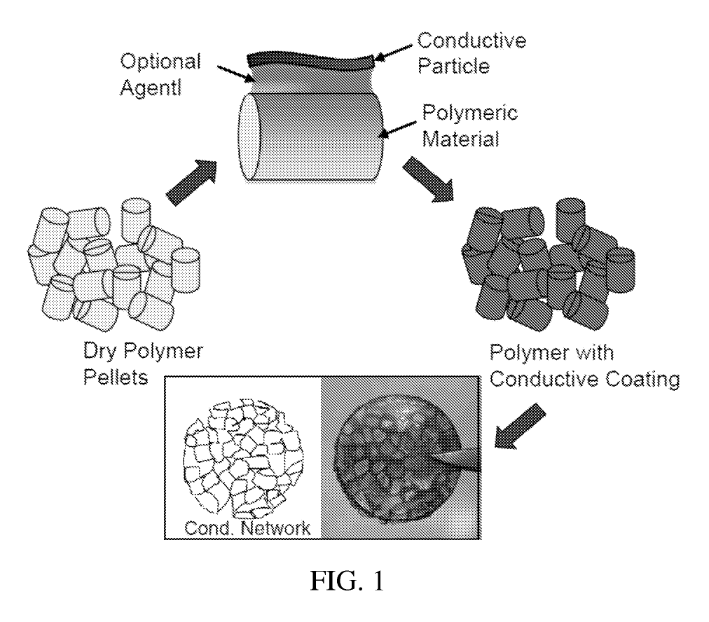

A two-step process was therefore utilized to produce the GNP/PS segregated composites. For composites consisting of less than 0.2% v/v, the desired amount of graphene platelets were measured and added directly to 7 g of dry PS pellets. The GNP spontaneously adheres to the dry polymer particles by physical forces, which may be by Van der Waals forces or electrostatic attraction associated with surface charges. This coating process works well for GNP loadings below 0.2% v/v. However, at higher GNP loadings, this dry method leaves behind excess GNP because the charge on the pellets is neutralized after the initial coating. To provide a means of temporarily attaching larger quantities of the GNP to the surface of the PS, an additional step is implemented during the fabrication procedure as shown in FIG. 1.

FIG. 1 illustrates capillary-driven particle-level templating technique used to fabricate the highly conductive GNP/PS coatings. For GNP loadings greater than 0.1% v/v, the PS is first soaked in a methanol bath. The excess methanol is drained from the PS pellets. GNP is added, and the mixture is then shaken vigorously, creating a dense coating of graphene on each PS pellet. The methanol temporarily moistens the polymer pellets forming small liquid bridges between the GNP and the pellet surface. The capillary pressure created through these bridges allows the GNPs to stick easily to the surface of the pellets.

During the subsequent hot melt pressing, the temperature and mold pressure are precisely controlled allowing the pellets to be consolidated into a monolith while maintaining boundaries. The methanol evaporates during the molding cycle. In experiments, a stainless steel mold consisting of a lower base and a plunger was heated to 125° C. The GNP coated PS was placed inside the cavity of the lower base and the plunger was placed on top.

The temperature of both the plunger and the base mold was maintained for 20 min at which point it was hot-pressed at 45 kN using a hydraulic press. By precisely controlling the temperature and pressure during a melt compression process, highly conductive composites were formed. This method of distributing graphene within a matrix overcomes the need to disperse the sheet-like conducting fillers isotropically within the polymer, and can be scaled up easily.

Modified particle-templated composites were fabricated by incorporating a shearing technique during the melt compression process. Following the same coating process as discussed earlier, the graphene coated pellets were placed inside a modified steel mold, which was equipped with guide pins to ensure that the base remained stationary. The plunger was then placed on top of the material and heated to 160° C. while the lower base mold was heated to 125° C. and maintained for 20 min. Next, 20 MPa was applied to the plunger and then rotated to various predetermined angles. Once the desired rotation was achieved, 45 MPa was applied and held for 5 min. All shear-modified composites were fabricated with 0.3% v/v graphene platelets.

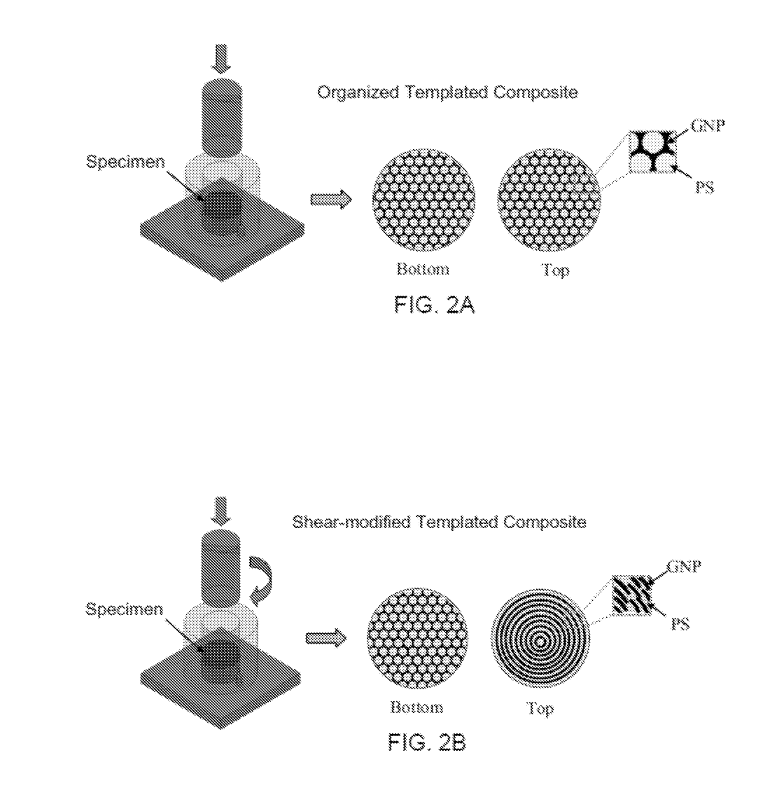

A schematic of the compression molding process used to produce both types of segregated composites is shown in FIG. 2A and FIG. 2B. FIG. 2A shows a schematic of the compression molding process to produce organized template composites, and FIG. 2B shows shear-modified template composites. By applying such a strain in the azimuthal direction on the top surface of the material, as shown in FIG. 2B, a gradient of graphene organization/orientation in the axial direction is formed which results in a composite possessing unique properties.

Electrical conductivity measurements were made on the GNP/PS composites using a volumetric two-point probe measurement technique. The bulk electrical conductivity was measured across the thickness of the sample (perpendicular to pressing). The resistance of the material was experimentally determined by supplying a constant current, ranging from 5 nA to 1 mA, through the specimen while simultaneously measuring the voltage drop across the specimen. A constant current source was used to supply the DC current while two electrometers were used to measure the voltage drop. The difference between the two voltage readings was measured using a digital multimeter.

A series of 3 point bend experiments were carried out to investigate the influence of graphene content on the flexural properties of the composites. A screw-driven testing machine was implemented to load the specimens in a three point bending configuration. Specimens were cut into 5×6×38 mm rectangular prisms. A support span of 30 mm was used and the loading was applied at a rate of 0.1 mm/min.

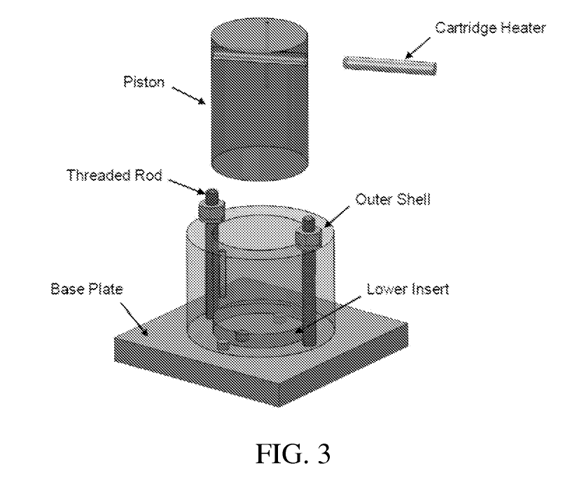

FIG. 3 shows a schematic of the molding apparatus. The mold consists of a base plate, lower insert, outer shell, piston and two heating elements. Additionally, the base of the mold may be equipped with guide pins to ensure that the base of the mold remains stationary during the melt compression process. Once the material was placed in the mold, the temperature of both the base and piston was increased to a temperature slightly above the glass transition temperature of the elastomeric material being used. This temperature was maintained to achieve a constant temperature gradient throughout the material. Next, a sufficient compressive force was applied on to the top of the piston. While the force was maintained, the piston was rotated to a desired angle. By applying such a strain in the azimuthal direction on the top surface of the material, a gradient of the filler organization/orientation in the axial direction is formed which results in a composite possessing unique physical and mechanical properties.

Examples of various conductive filler materials that may be used include graphite/carbon-based materials (carbon black, graphene, graphite nanoplatelets, single walled carbon nanotubes, multi-walled carbon nanotubes, carbon fibers, fullerene, etc.), silver conductive materials (flakes/fibers), gold conductive materials (flakes), and alumnimum conductive materials (flakes/fibers).

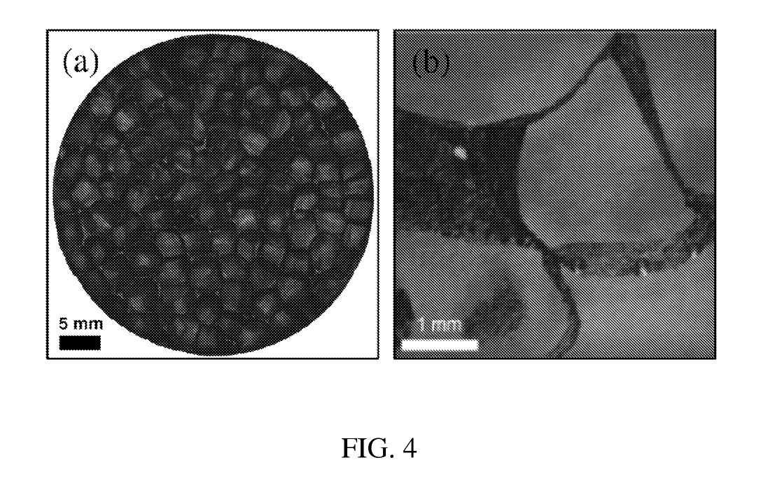

FIG. 4 shows optical microscope images of (a) top surface, and (b) cross-section of a 0.05% v/v GNP/PS composite. As seen in FIG. 1, the composite (with 0.3% v/v GNP) has a foam-like or honeycomb-like structure in which the dark wall-like structures are GNP while the lighter domains are the PS. Images of a 0.05% v/v GNP/PS composite exhibiting this segregated structure are shown in FIG. 4.

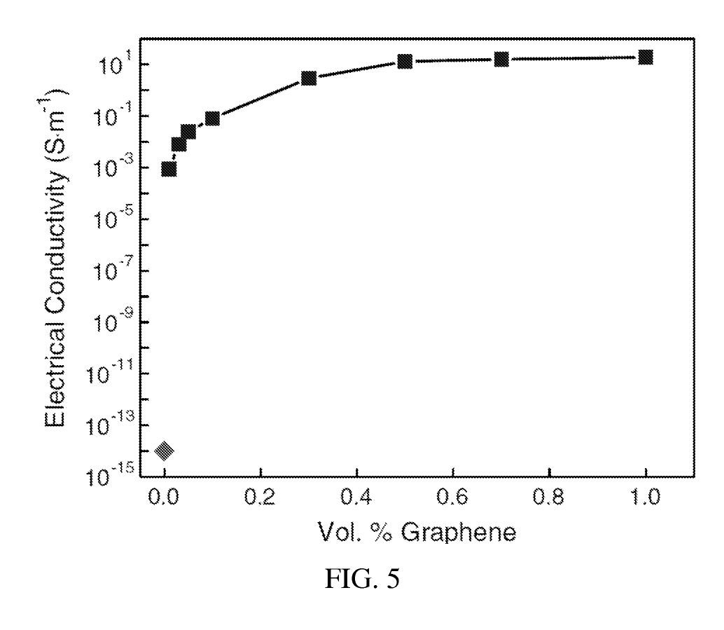

FIG. 5 shows the electrical conductivity as a function of graphene loading. A significant enhancement in electrical conductivity is demonstrated when 0.01% v/v GNP was added to the PS. Since the boundaries located between the pellets are maintained, the graphene particles become interconnected throughout the material thus causing a significant increase in conductivity while using very low loadings of graphene. The capillary driven coating process enables more graphene to completely coat the surface of the PS which in turn increases the electrical conductivity of the composite approximately 4-5 orders of magnitude from 0.01 to 0.3% v/v.

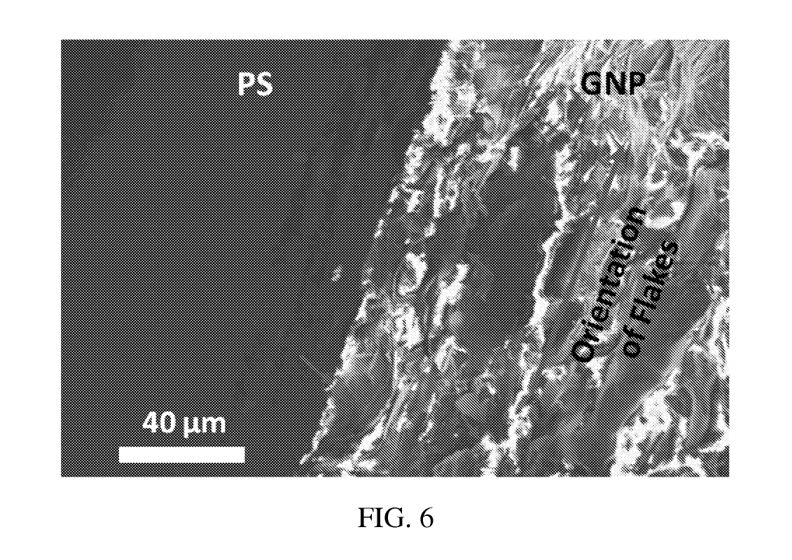

FIG. 6 shows a scanning electron microscope (SEM) image showing a section view of a 5% v/v GNP/PS segregated composite. It appears that the majority of the GNP flakes are oriented along the PS/PS interface. This alignment of the large graphene sheets enables efficient utilization of the high aspect ratio while also allowing for efficient electron transfer between the graphene particles. These micro-scale interactions further contribute to the exceptional conductivity demonstrated at very low loading fractions. While the segregation of the GNPs imparts exceptional transport capabilities, there is an inherent loss in the mechanical strength because of easy fracture by delamination along the continuous graphene honeycomb network.

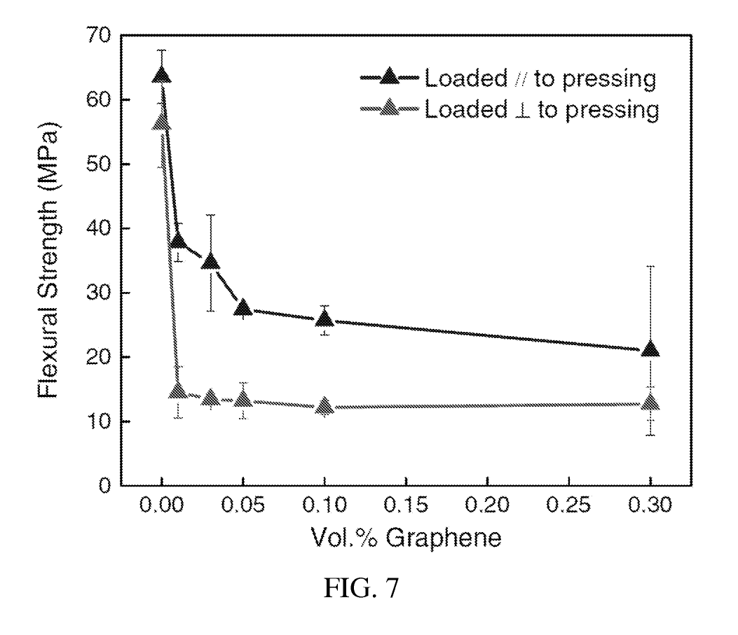

FIG. 7 shows the flexural behavior of the organized GNP/PS composites as a function of graphene loading. Specimens were loaded in two different configurations, parallel and perpendicular to the melt compression, to fully characterize the material in bending. For both loading cases, the flexural strength of the resulting composite decreased significantly with the introduction of GNPs. Since the temperature of the material prior to pressing is maintained at a temperature slightly below the melting temperature of the PS, the interaction between the styrene chains is limited. The GNPs, located at the interfaces of the PS pellets, further inhibit complete tangling of the polymer chains during the melt compression process thus diminishing the flexural strength of the composite.

As shown in FIG. 7, the composites also demonstrate anisotropic behavior. This anisotropy of mechanical strength is believed to be a consequence of the melt compression process. Since the softened PS pellets are compressed along the loading direction during the melt compression process, the PS pellets become elongated in the plane perpendicular to compression. The elongation of the PS pellets in turn causes a directional dependence on the flexural strength of the composite when subjected to bending.

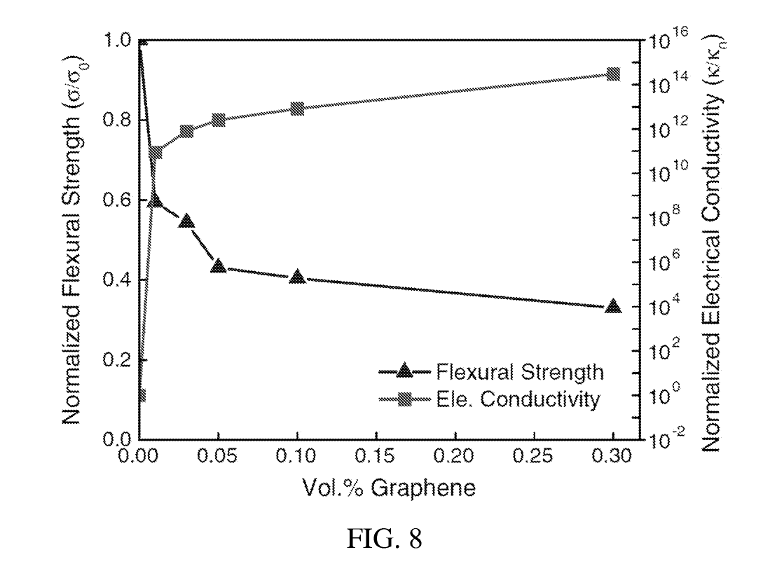

FIG. 8 shows the coupled electro-mechanical behavior of the GNP/PS organized particle templated composite, when loaded parallel to the pressing direction. The flexural strength and electrical conductivity is normalized with respect to the flexural strength (σ₀) and electrical conductivity (κ₀) of the pristine PS particle templated composite (0% v/v GNP), respectively. It can be seen that the highly segregated GNP network, although very efficient for electron transfer, causes a significant decrease in flexural strength.

While the conducting pathways provided by the graphene, located at the particle interfaces of the PS, allow percolation at a graphene loading less than 0.01% v/v GNP, they also cause the flexural strength of the composite to decrease by ˜40%. As the GNP loading is further increased, the electrical efficiency of the networks continues to increase while the flexural strength is decreased.

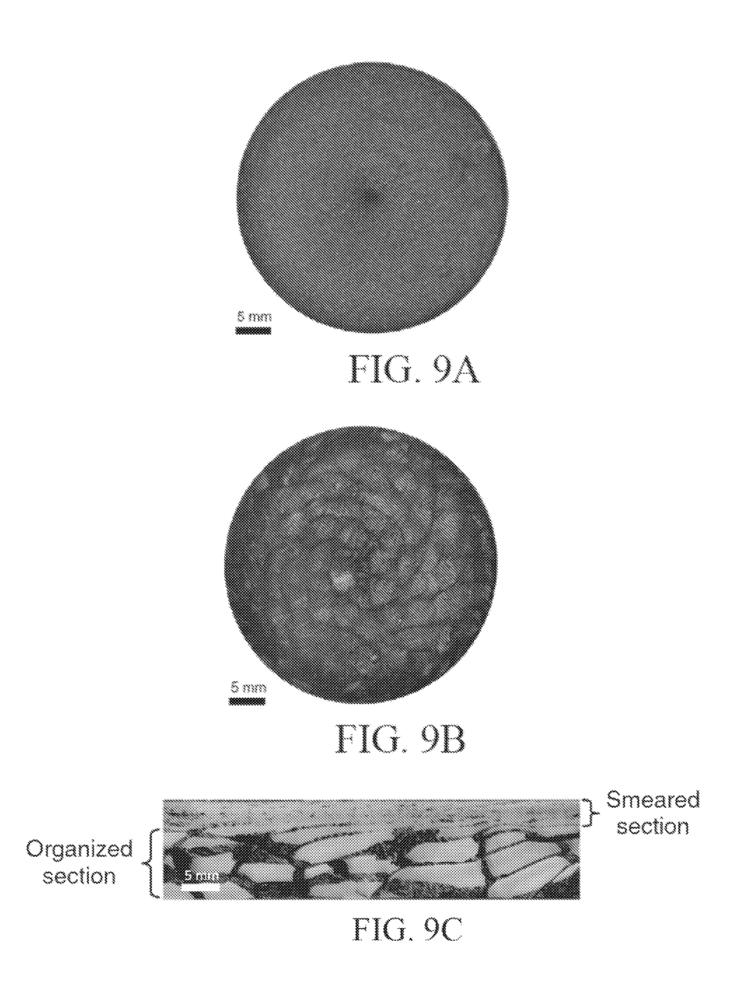

FIGS. 9A-9C show optical images of a 0.3% v/v GNP/PS shear modified specimen exhibiting a graphene network that is functionally graded in the axial direction. FIG. 9A shows the top surface of the composite exhibits a chaotic and disorganized pattern of GNP, while FIG. 9B shows the bottom surface maintains a highly organized segregated structure of GNP. The top surface was rotated 360°. FIG. 9C shows optical images of a cross-section of a 0.3% shear modified composite, showing the extent of smearing.

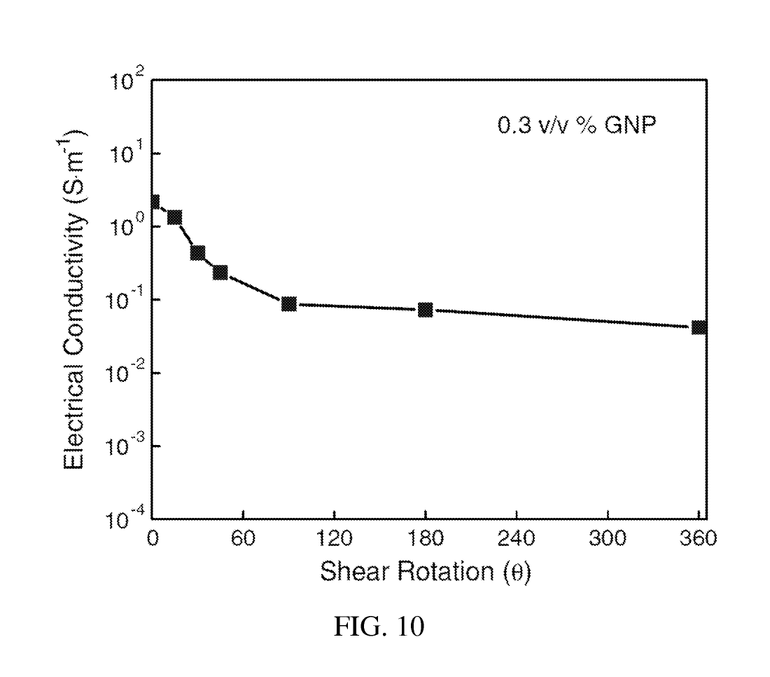

FIG. 10 shows the effect of azimuthal strain on the top surface on the electrical conductivity of the shear-modified GNP/PS composite. The electrical conductivity decreased from ˜3 S m⁻¹ to ˜4×10⁻² S m⁻¹ when the plunger was rotated 90° during the compression process. Although, the electrical conductivity decreased by two orders of magnitude, the value of 4×10⁻² S m⁻¹ is still very high and acceptable for many applications. The decrease in electrical conductivity can be attributed to the partial disruption of the GNP networks within the polymer, as shown in FIG. 9C. Further rotation of the plunger resulted in only a slight decrease in conductivity.

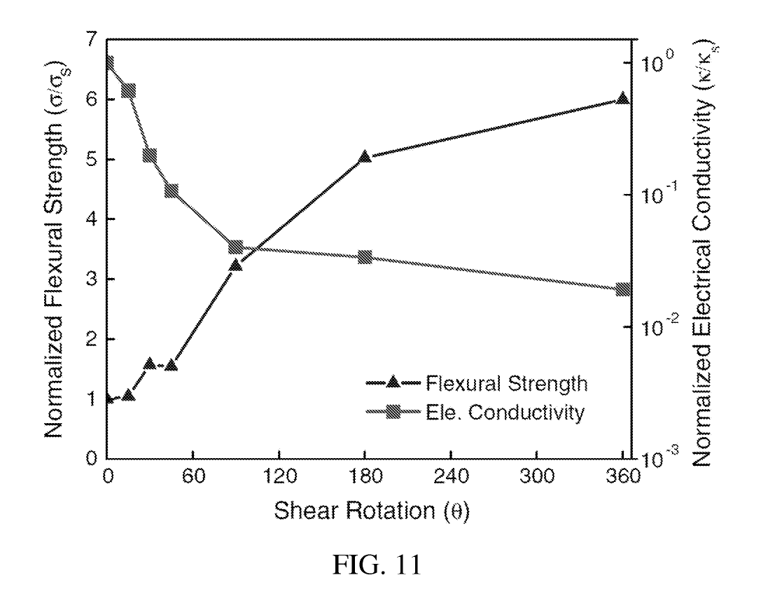

FIG. 11 shows the electro-mechanical behavior of the shear-modified GNP/PS composites as a function of shear rotation. The flexural strength and electrical conductivity are normalized with respect to the flexural strength (σₛ) and electrical conductivity (κₛ) of the particle templated composite with no shear rotation (0.3% v/v GNP), respectively. The capillary driven coating process enabled an increase in electrical conductivity of the composite by approximately 14-15 orders of magnitude as compared to the pristine PS, owing to the dense coating of GNP on the PS pellets. By applying a shear force to the top surface of the highly segregated material, a gradient of graphene organization/orientation along the sample axis is formed which results in a 600% increase in flexural strength while only sacrificing ˜1-2 orders of magnitude of conductivity. To further tune the properties of the composite, the extent of disorganization of the GNPs can be controlled by adjusting the preload and/or temperature of the piston during melt compression.

In accordance with various embodiments, therefore, the invention provides a simple, inexpensive, and commercially viable technique that can be used to disperse conductive 2D and 3D (sheet-like) materials, such as graphene, into specifically constructed hybrid architectures within polymeric materials on either the micro- or macro-scale. Utilizing capillary interactions between polymeric particles and graphite nanoplatelets, liquid bridges on the surface of the polymeric material allows for the coating of graphene onto the polymer surfaces. By precisely controlling the temperature and pressure during the melt compression process, highly conductive composites are formed using very low loadings of graphene particles.

Since the graphene particles are localized at the boundaries between the polymer matrix particles, the composite exhibited poor mechanical strength. To improve the mechanical properties of the composite, a controlled amount of rotary shear was applied to the top surface of the material to create a Z-directional gradient of graphene organization/orientation along the sample axis. Results showed that this novel fabrication technique can produce composite materials that possess both excellent transport properties and improved mechanical strength.

In addition to producing composite materials that possess exceptional transport properties, this technique can also be used to enhance other physical and mechanical properties such as gas barrier properties. If efficiently distributed and oriented, graphite-based fillers can greatly enhance the impermeability of the resulting composite material.

In summary, techniques of the invention may be used to alter the properties of a composite material and the inherent trade-off between the mechanical and other physical properties of the composite can be optimized for a given application by controlling the pre-set angle of rotary shear.

Those skilled in the art will appreciate that numerous modifications and variations may be made to the above disclosed embodiments without departing from the spirit and scope of the invention.

1. A method for forming a multi-functional electrically conductive composite, said method comprising the steps of coating an electrically conductive material on particles of a polymeric material, and applying a stress force on the coated polymeric material to cause the polymeric material to become deformed and the electrically conductive material to break into smaller sized particles.

2. The method as claimed in claim 1, wherein said step of applying a stress force includes applying a rotary shear force to the composite.

3. The method as claimed in claim 2, wherein the rotary shear force is applied perpendicular to a direction of compression.

4. The method as claimed in claim 1, wherein said step of applying a stress force includes applying heat to the composite.

5. The method as claimed in claim 1, wherein said method further includes the step of coating the particles of the polymeric material with methanol prior to coating the particles of the polymeric material with the electrically conductive material.

6. The method as claimed in claim 1, wherein said polymeric material includes polystyrene, polypropylene, polyethylene, high impact polystyrene, vinyl, nylon, polybutylene, polyimide, or polyphthalamide.

7. The method as claimed in claim 1, wherein said electrically conductive material includes graphite particles, carbon-based materials, silver conductive materials, gold conductive materials, or aluminum conductive materials.

8. The method as claimed in claim 7, wherein said graphite particles are graphite nanoplatelets.

9. The method as claimed in claim 2, wherein said electrically conductive material forms a honeycomb network along boundaries between polymer particles.

10. The method as claimed in claim 9, wherein said honeycomb network changes into a concentric band structure by a desired angle of rotation.

11. An electrically conductive composite comprising a plurality of particles of polymeric material and a conductive material, wherein the conductive material at least partially covers the plurality of particles of polymeric material, and wherein a first portion of the composite has undergone a stress force that has deformed a first portion of the polymeric material and broken up the conductive material associated with the first portion of the polymeric material.

12. The electrically conductive composite as claimed in claim 10, wherein a second portion of the composite that has not undergone the stress force includes a second portion of the particles of polymeric material that remain not deformed and remain at least partially coated by the conductive material.

13. The electrically conductive composite as claimed in claim 10, wherein said stress force is a shear force.

14. The electrically conductive composite as claimed in claim 10, wherein said polymeric material includes polystyrene, polypropylene, polyethylene, high impact polystyrene, vinyl, nylon, polybutylene, polyimide, or polyphthalamide.

15. The electrically conductive composite as claimed in claim 10, wherein said conductive material includes graphite particles, carbon-based materials, silver conductive materials, gold conductive materials, or aluminum conductive materials.

16. The electrically conductive composite as claimed in claim 15, wherein said graphite particles includes graphite nanoplatelets.

17. An electrically conductive composite comprising polymeric material that has undergone a stress force, and a plurality of particles of conductive material that are dispersed within the composite.

18. The electrically conductive composite as claimed in claim 17, wherein said stress force is a shear force.

19. The electrically conductive composite as claimed in claim 17, wherein said polymeric material includes polystyrene, polypropylene, polyethylene, high impact polystyrene, vinyl, nylon, polybutylene, polyimide, or polyphthalamide.

20. The electrically conductive composite as claimed in claim 17, wherein said conductive material includes graphite particles, carbon-based materials, silver conductive materials, gold conductive materials, or aluminum conductive materials.

21. The electrically conductive composite as claimed in claim 20, wherein said conductive material includes graphite nanoplatelets.

22. The electrically conductive composite as claimed in claim 17, wherein said electrically conductive composite includes a first portion that has undergone the stress force that caused deformation of polymeric particles, and a second portion that has not undergone the stress force.

23. A molding apparatus comprising a base plate for securing an element to be molded within a housing, a piston for urging the element in a first direction and in a rotational direction that is orthogonal to the first direction, a heating element.
